(19) United States
(12) Patent Application Publication
(10) Pub. No.: US 2004/0135322 A1
(43) Pub. Date: Jul. 15, 2004

(54) Flat sealing ring

(76) Inventors: Rainer Weisbrodt, Ilvesheim (DE); Josef Braun, Hockenheim (DE); Alexander Bubb, Schwetzingen (DE)

Correspondence Address: Simpson & Simpson PLLC, 5555 Main Street, Williamsville, NY, 14221, US

(21) Appl. No.: 10/696,840

(22) Filed: Oct. 30, 2003

(30) Foreign Application Priority Data
Nov. 9, 2002 (DE) 10252141.7

(51) Int. Cl. H02G 15/04; F16L 17/06

(52) U.S. Cl. 277/608

(57) ABSTRACT

A flat sealing ring (1) for producing a fluid-tight coupling of two surfaces which are to be sealed against one another by means of a contact force, the ring (1) having an elastically deformable base ring (2), wherein a stiffening ring (3, 3′, 3″) is provided at at least one of the inner circumferential edge of the base ring (2) or the outer circumferential edge of the base ring (2), wherein the stiffening ring, at least perpendicularly to the ring plane, has a lesser deformability, or greater firmness, than the base ring (2), and wherein the height of the stiffening ring perpendicularly to the ring plane is less than the greatest height of the base ring (2) perpendicularly to the ring plane.

### BACKGROUND OF THE INVENTION

The invention relates to a flat sealing ring for producing a fluid-tight coupling of two flanges which are to be sealed off against one another by means of a contact force, the ring having an elastically deformable base ring. More particularly, the invention relates to a flat sealing ring, having resilience and defined compression, which, in a special design, can be advantageously used in the chemical, petrochemical and food processing industries if it is provided with a surface layer which is chemically stable and/or safe in respect of health.

Flat gaskets or flat sealing rings with a high load capacity are used in apparatus, pump and pipeline engineering to produce fluid-tight couplings. The flat sealing rings are compressed either by a rotary motion about the central axis of the sealing ring, as in the case of, for example, threaded joints of valve bodies in pipelines or pump casings, or by pressure movements perpendicular to the plane of the sealing ring, i.e., parallel to the axis of the sealing ring, for example, in the case of flange couplings between two pipeline sections. The compression ensures a firm, close contact between the sealing material and the two parts which are to be coupled together in a fluid-tight manner.

Flat gaskets made from pure PTFE (polytetrafluoroethylene) are known which, due to their chemical stability and safety in respect of health, are used primarily in the chemical, petrochemical and food processing industries. A disadvantage of these seals is that the PTFE material is not elastic, and therefore does not possess an elastic restoring force. In principle, therefore, these seals made from pure PTFE or from another non-elastic material can be used only once. Such seals cannot be used at all if an elastic restoring force is expressly required, or if it is necessary that the fluid-tight coupling between two parts be opened relatively frequently. PTFE seals can be compressed only to a limited extent and have a tendency to “yield” with the result that the tightening torques of a threaded joint, or the force with which the compression was originally effected, become slack after a certain period of operation. Consequently, in the course of time a leakage can then also occur if the seal is compressed only once and not subsequently slackened.

Known from DE 299 09 268 U and DE 299 09 270 U are flat sealing rings, with which it is attempted to overcome the disadvantages of pure PTFE gaskets. The sealing rings consist, in essence, of two PTFE layers which, in the region of compression, form an intermediate enclosure or pocket in which there is provided a ring composed of a metal foil which is corrugated perpendicularly to the ring plane. Alternatively, an insert composed of an elastic material is provided in the PTFE enclosure or PTFE pocket. When the seals with a corrugated metal ring insert are compressed, the metal corrugations are pressed flat under the compression force. This type of seal ensures tightening or compression with predefined tightening torques, and a durably reliable sealing effect. In the case of plastic screwed joints, however, seals with a corrugated metal insert can be used only to a limited extent, since the seal is generally too hard for the plastic material. More suitable for plastic screwed joints in this case are seals with an insert composed of an elastic material which, in the case of the known seals, is inserted loosely in the PTFE enclosure. It has been shown, however, that, upon tightening of threaded joints, rotary motion causes the insert composed of elastic material to be forced outwards, out of one side of the PTFE enclosure, and the PTFE enclosure slides away. A reliable sealing of the screwed joint cannot therefore be guaranteed. The forced-out insert composed of elastic material also frequently binds the thread of the threaded joint, rendering it more difficult to tighten and maintain.

DE 198 46 475 A1 describes a further flat sealing ring, in which a base ring composed of an elastic material is covered with a protective film of PTFE. The elastic material and the protective PTFE film are joined together in such a way that, when the seal is compressed, the elastic material is no longer forced out. The seal has the disadvantage, however, that it does not afford a constant surface pressure or sealing force over a long period of operation, due to the fact that the tightening forces, or contact forces, are directly and fully absorbed by the ring composed of elastic material and covered with PTFE protective film (force series). As a result, the seal can easily undergo excessive compression. The seal easily undergoes excessive crushing and permanent deformation, as a result of which the seal becomes unsuitable for re-use, or the sealing effect is lost following opening and recompression of the seal.

### BRIEF DESCRIPTION OF THE INVENTION

The object of the present invention, therefore, is to provide a flat sealing ring by means of which both threaded joints and flange couplings can be reliably sealed, which can be used several times and which can be compressed with predefined tightening torques.

This object is achieved, according to the invention, by a flat sealing ring of the initially mentioned type, which is characterized in that a stiffening ring is provided at the inner circumferential edge of the base ring and/or at the outer circumferential edge of the base ring, wherein the stiffening ring, at least perpendicularly to the ring plane, has a lesser deformability, or greater firmness, than the base ring, and wherein the height of the stiffening ring perpendicularly to the ring plane is less than the greatest height of the base ring perpendicularly to the ring plane.

### BRIEF DESCRIPTION OF THE DRAWINGS

FIG. 1 shows a flat sealing ring according to the invention, in cross section, with a stiffening ring at the outer circumferential edge of the base ring.

FIG. 2 shows a further version of the flat sealing ring according to the invention, in cross section, with a stiffening ring at the inner circumferential edge of the base ring.

FIG. 3 shows a further version of the flat sealing ring according to the invention, in cross section, with a stiffening ring at the outer circumferential edge of the base ring.

FIG. 4 shows the use of the flat sealing ring according to the invention shown in FIG. 3 for sealing off the transition between two pipeline sections.

FIG. 5 shows the use of the flat sealing ring according to the invention in a flange coupling.

FIG. 6 shows the use of the flat sealing ring according to the invention shown in FIG. 3 for sealing off a valve in an installation.

FIG. 7 shows the use of the flat sealing ring according to the invention shown in FIG. 3 for sealing off a valve in a pump metering head.

### DETAILED DESCRIPTION OF THE INVENTION

The base ring of the flat sealing ring according to the invention is composed fully, or at least in its core, of elastically deformable material, for which any suitable elastomer may be used. Rubber, as solid material or foam material, is preferably used for this purpose. The elastically deformable material of the base ring ensures the resilience of the seal and causes the flat sealing ring to rest, in a uniform and durable manner, against the parts which are to be coupled together.

Since, in the usual fields of application for such flat sealing rings, the elastically deformable material of the base ring frequently does not fulfill the requirements in respect of chemical stability and/or the requirements in respect of safely as regards health, for example when used in the food processing industry, the elastic material of the base ring is provided, in a quite particularly advantageous version of the invention, at least in portions, with one or more protective layers of appropriate material on its surface. Suitable as a protective layer is any material known in the field which has the required chemical stability and/or safety in respect of health, together with the required suitability for fluid-tight sealing. A protective layer of PTFE is particularly preferred. The protective layer is disposed over the elastic material, at least wherever the seal can come into contact with the fluid, against the leakage of which the flat sealing ring according to the invention is intended to protect. The protective layer extends expediently over the entire upper side of the base ring, from there over the inner surface of the ring, and to over the underside of the ring. Alternatively, the entire elastic material of the base ring can also be enclosed by the protective layer. In the case of a further version, several layers, or protective layers, are provided over one another in the form of strata over the elastic material of the base ring, in which case the outermost layer, which comes into contact with fluid, should have the properties of the aforementioned individual protective layer.

The stiffening ring provided according to the invention has a lesser deformability, or greater firmness, than the base ring, which is composed of at least the elastic material and, preferably disposed over the latter, one or more protective layers. The stiffening ring is preferably produced from a hard plastic such as polyamide, or from metal. Rustproof or corrosion-resistant metal, preferably stainless steel, is particularly suitable. At the same time, in the direction perpendicular to the ring plane, i.e., parallel to the central axis of the ring, the stiffening ring is of a lesser height, or extent, than the base ring. In the case of the application and compression of the flat sealing ring according to the invention, the parts which are to be coupled together in a fluid-tight manner are moved towards one another, whether by threaded-joint coupling or pressure movement perpendicular to the ring plane. In the case of movement of the parts towards one another, both parts at first come into contact with the base ring, and the base ring becomes elastically deformed, i.e., crushed, upon compression. The elastic restoring force of the elastic material ensures in this case that the base ring comes to rest uniformly, in a fluid-tight manner, on the surfaces of the parts to be sealed. The stiffening ring performs the function of limiting the seal compression. As soon as both parts which are to be coupled bear on the stiffening ring, the parts cannot be moved further towards one another and the elastically deformable base ring cannot be further compressed. This prevents the elastically deformable base ring from being excessively crushed, or even forced out laterally or possibly damaged. The elastically deformable base ring which is responsible for the actual sealing is protected against damage and can thus durably perform its sealing function, and can also be re-used following repeated opening of the seal. The stiffening ring prevents not only excessive, but also insufficient compression, since by limiting the compression it indicates both the minimum and the maximum compression. The tightening torques remain durably constant.

It is particularly preferred that the flat sealing ring according to the invention has precisely one stiffening ring, extending either at the inner circumferential edge of the base ring or at the outer circumferential edge of the base ring. It is thus ensured, upon compression of the flat sealing ring, that the elastically deformable base ring, which becomes flatter and wider upon compression, can yield in the direction opposite to that of the stiffening ring. If the stiffening ring extends at the outer circumferential edge of the base ring, the elastically deformable material can yield, upon compression, in the direction of the ring center, and vice versa. It may also be expedient, however, depending on the requirements for and design of the elastically deformable base ring, if two stiffening rings are provided, one at the inner and one at the outer circumferential edge of the base ring.

The stiffening ring is expediently joined to the base ring in a firm or form-locking manner. In a preferred version, the stiffening ring is positively vulcanized into the elastically deformable material of the base ring, the stiffening ring being completely or, also, only partially enclosed by the elastic material. In an alternative version, the base ring and stiffening ring are joined by injection molding or adhesion production methods, known per se, which are suitable for such joining.

In a preferred version of the flat sealing ring according to the invention, the stiffening ring is produced from the same material as the protective layer disposed over the base ring, and formed as a single piece with this protective layer. This is quite particularly advantageous if the material is a chemically stable material, in particular, PTFE or PTFE-like materials. In the case of this variant, the stiffening ring has the same advantageous chemical stability against corrosion, as a result of which the stability of the stiffening ring is substantially improved compared with other materials such as, for example, a metal stiffening ring. Since the protective layer is generally in the form of a relatively thin film, the material of the stiffening ring formed as a single piece with the protective layer has a greater material thickness, in order to achieve the desired height of the stiffening ring. Particularly suitable for forming the stiffening rig and protective layer as a single piece are those chemically stable materials which are essentially non-compressible or only slightly compressible, in order to also fulfill the mechanical requirements for the stiffening ring. PTFE is a suitable material for this purpose.

The present invention is intended to also include modifications of the previously described stiffening ring, in which the stiffening ring does not fully have a lesser deformability, or greater firmness, than the base ring. It may be sufficient, and advantageous for the purpose of saving material, if a material having a lesser deformability than the base ring is provided which is distributed at several locations in the circumferential direction. In a further alternative design, instead of a complete stiffening ring, only individual elements which are not joined to one another may also be distributed, these elements having a lesser deformability than the base ring, but, like the stiffening ring described above, being of a lesser height than the base ring. Such elements may be ring segments or also, for example, plates or discs of a solid material which are cast into the elastic material of the base ring. A prerequisite is that these elements perform the functions, described above, of the stiffening ring, namely, to limit the compression upon installation of the seal.

The base ring of the flat sealing ring according to the invention preferably has a cross section which extends in a flat manner in the ring plane, i.e., essentially in the form of a washer. It is particularly preferred that the cross section of the base ring has at least one bead which, proceeding from the upper side and underside of the base ring, which are flat in cross section, extends upwards and downwards, i.e., towards the bearing surfaces of the parts which are to be coupled together in a fluid-tight manner. The bead extends in the circumferential direction preferably over the entire circumference of the base ring and, in the case of alternative designs, it may be expedient to provide two or more beads in the cross section of the base ring. The use of one or more beads on the sealing surface effects a partial additional increase in the compression, thereby improving the seal tightness, particularly in the case of media which emit gas or in the case of uneven sealing surfaces.

Further advantages, features and design possibilities are disclosed with reference to the following description of several versions and the associated figures.

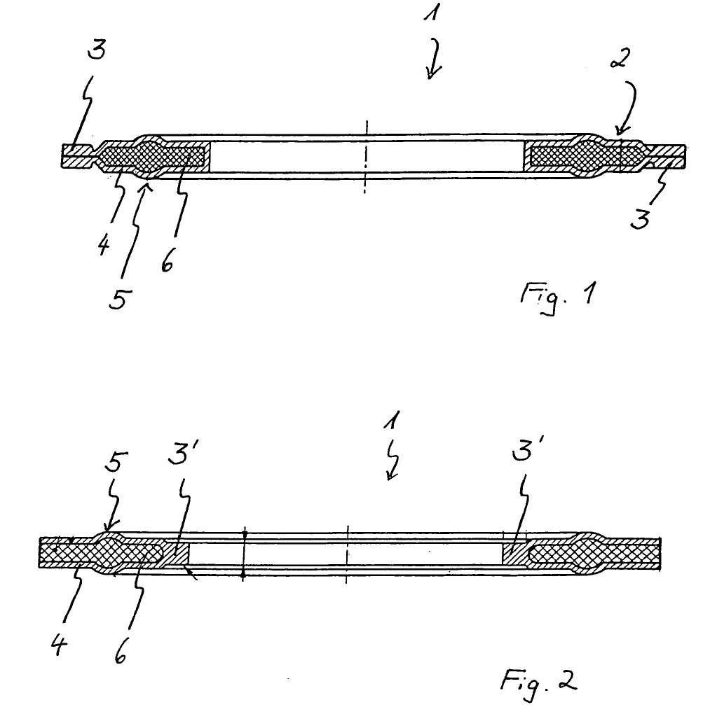

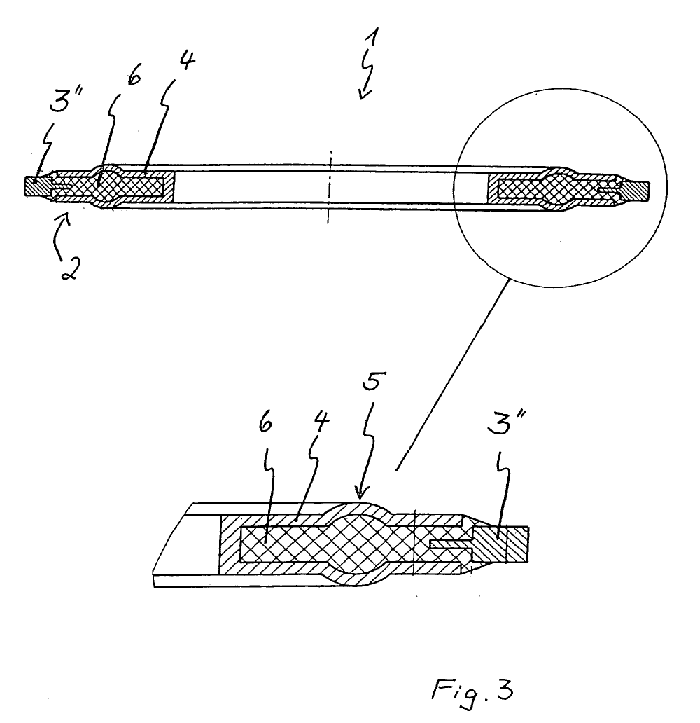

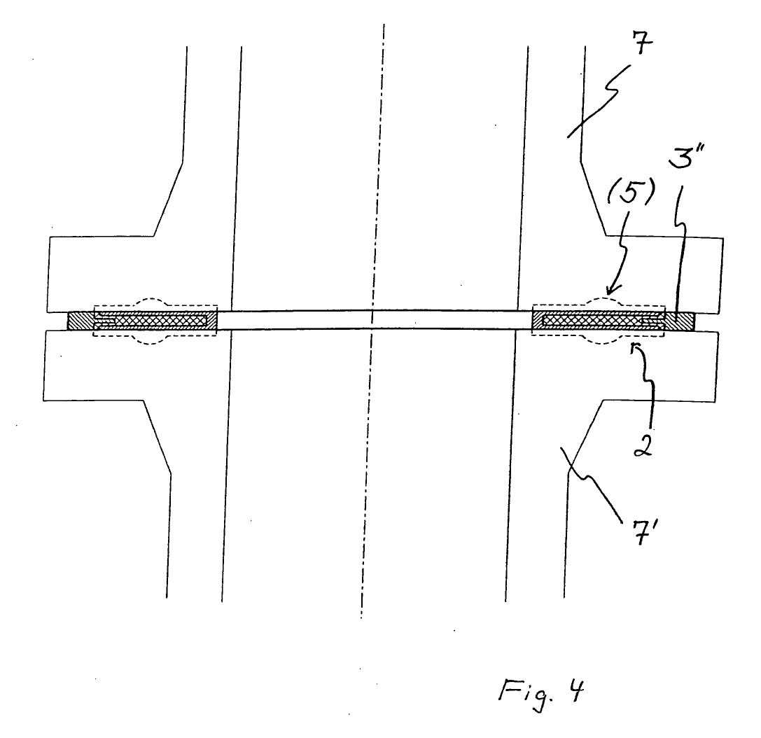

FIGS. 1, 2 and 3 show alternative versions of the flat sealing ring 1 according to the invention with, in each case, a base ring 2 and a stiffening ring 3, 3′ and 3″ respectively, wherein, in the variants according to FIGS. 1 and 3, the stiffening rings 3 and 3″ respectively extend at the outer circumferential edge of the base ring 2. In the variant according to FIG. 2, the stiffening ring 3′ extends at the inner circumferential edge of the base ring 2. The base ring 2 of all versions of FIGS. 1, 2 and 3 is composed of an elastically deformable material 6 which is enclosed at least partially by a protective layer 4. The protective layer 4 is expediently composed of a PTFE film which protects the elastically deformable material 6 against attack by chemically aggressive fluid. The base rings 2 of the flat sealing rings represented in FIGS. 1, 2 and 3 each have a continuous bead 5 which, in the cross section of the base ring, are represented as projections upwards and downwards from the otherwise flat surface.

In the variant according to FIG. 1, the elastically deformable material 6 of the base ring 2 is completely enclosed by the protective layer 4 and, at the outer circumference of the ring, the protective layer 4 merges into the stiffening ring 3. The stiffening ring 3 in this case can be produced from the same material as the protective layer 4. The stiffening ring 3 is disposed centrally relative to the base ring 2 in the axial direction and, in the axial direction, is of a lesser height than the base ring 2.

In the variant according to FIG. 2, the stiffening ring 3′ extends at the inner circumferential edge of the base ring 2 and, as in the case of the variant according to FIG. 1, is likewise formed as a single piece with the material of the protective layer 4. The protective layer 4 is provided on the upper side and underside of the base ring 2, and extends around the inner surface of the base ring 2. The outer edge of the base ring 2, which cannot come into contact with fluid, is not covered by the protective layer 4.

In the variant according to FIG. 3, the stiffening ring 3″ is provided at the outer circumferential edge of the base ring 2 although, in contrast with the variants according to FIGS. 1 and 2, it is not formed as a single piece with the material of the protective layer 4. In the variant according to FIG. 3, the stiffening ring 3″ is composed of hard plastic or metal, and is embedded in form-locking manner into the elastically deformable material 6 of the base ring 2.

FIG. 4 shows the mounting of the flat sealing ring according to FIG. 3 between the coupling ends of two pipe sections 7 and 7′, the original, non-compressed basic form of the flat sealing ring, or of its base ring 2, being represented in FIG. 4 by broken lines. It is clearly evident that, in the non-compressed state, the base ring 2 with the bead 5 which is present in the non-compressed state is substantially higher than in the compressed state. In the compressed state, the base ring 2 assumes precisely the same height as the stiffening ring 3″ which limits the compression.

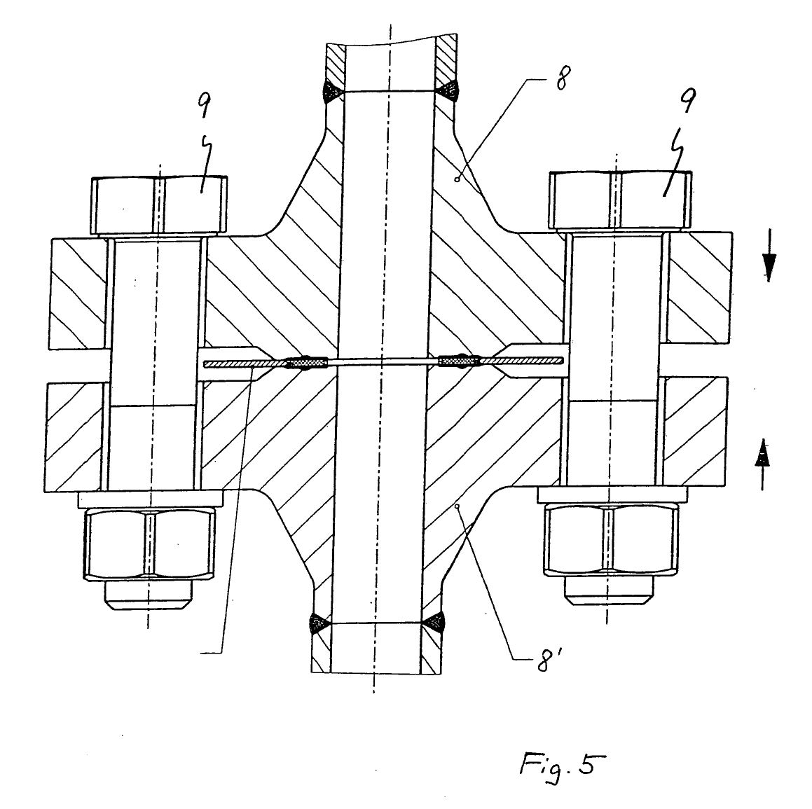

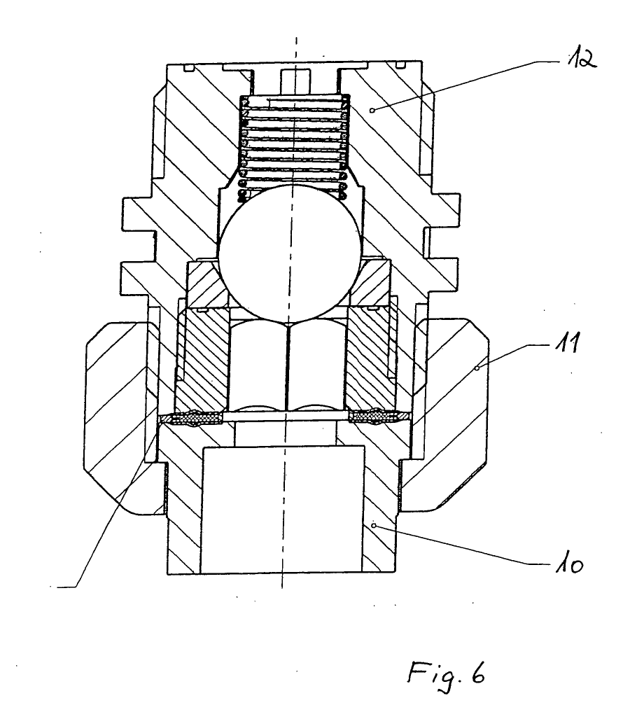

FIGS. 5, 6 and 7 show examples of the use of the flat sealing ring according to the invention. According to FIG. 5, the flat sealing ring according to the invention is inserted in a flange, consisting of two pipe sections 8 and 8′ which are to be coupled and bolts 9. When creating the seal, the pipe sections 8 and 8′ are moved towards one another by screwing the bolts in the direction of the two arrows indicated, and the flat sealing ring is precisely compressed in the axial direction.

FIG. 6 shows the use of the flat sealing ring according to the invention shown in FIG. 3 for a fluid-tight coupling between a fluid coupler 10 and a valve body 12 by means of a screwed joint effected by the nuts 11. Here, likewise the fluid sealing ring is compressed in the axial direction relative to the ring when the fluid coupler 10 and the valve body 12 are moved towards one another by tightening of the nuts 11.

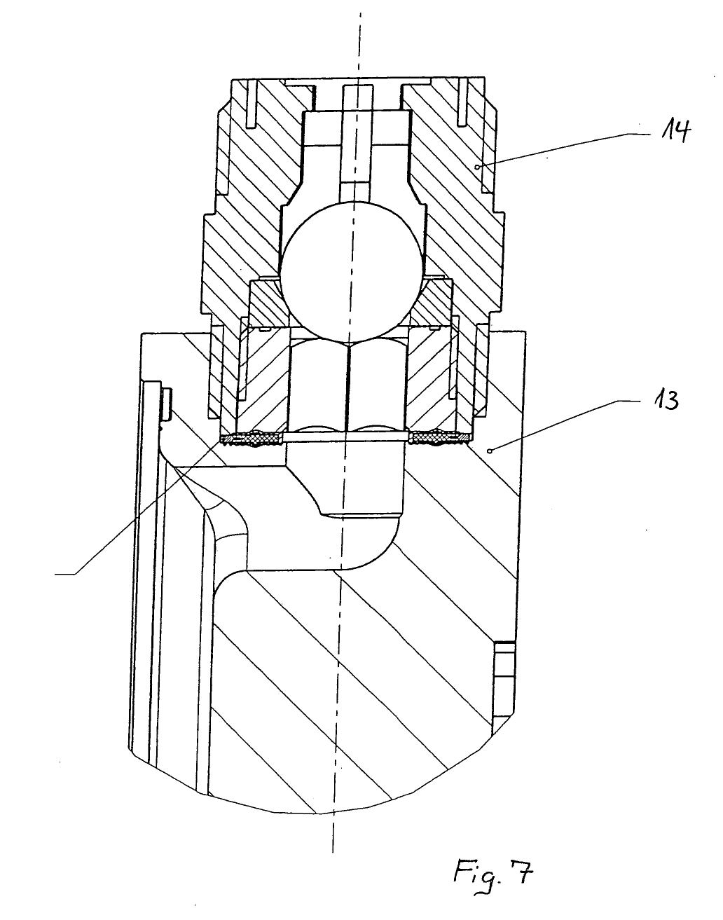

FIG. 7 shows the use of the flat sealing ring according to the invention for the fluid-tight coupling of a pump metering head 13 to a valve 14. Here, the surfaces between the pump metering head 13 and valve 14 which are to be sealed off are compressed and moved towards one another by screwing in of the valve 14, and thus by a rotary motion about the axis of the ring.

What is claimed is:

1. A flat sealing ring (1) for producing a fluid-tight coupling of two surfaces which are to be sealed against one another by means of a contact force, the ring (1) having an elastically deformable base ring (2), wherein a stiffening ring (3, 3′, 3″) is provided at at least one of the inner circumferential edge of the base ring (2) or the outer circumferential edge of the base ring (2), wherein the stiffening ring, at least perpendicularly to the ring plane, has a lesser deformability, or greater firmness, than the base ring (2), and wherein the height of the stiffening ring perpendicularly to the ring plane is less than the greatest height of the base ring (2) perpendicularly to the ring plane.

2. A flat sealing ring according to claim 1, wherein the stiffening ring (3, 3′, 3″) comprises plastic or metal.

3. The sealing ring according to claim 1 wherein the stiffening ring is made of metal.

4. The sealing ring according to claim 1 wherein the stiffening ring is made of stainless steel.

5. A flat sealing ring according to claim 1 wherein the base ring has a core of elastically deformable material (6) and at least one protective layer (4), at least in portions, on the elastically deformable material of the core.

6. A flat sealing ring according to claim 2 wherein the base ring has a core of elastically deformable material (6) and at least one protective layer (4), at least in portions, on the elastically deformable material of the core.

7. A flat sealing ring according to claim 3 wherein the base ring has a core of elastically deformable material (6) and at least one protective layer (4), at least in portions, on the elastically deformable material of the core.

8. A flat sealing ring according to claim 4 wherein the base ring has a core of elastically deformable material (6) and at least one protective layer (4), at least in portions, on the elastically deformable material of the core.

9. A flat sealing ring according to claim 5, wherein the at least one protective layer (4) is produced from a chemically resistant material.

10. A flat sealing ring according to claim 6, wherein the at least one protective layer (4) is produced from a chemically resistant material.

11. A flat sealing ring according to claim 7, wherein the at least one protective layer (4) is produced from a chemically resistant material.

12. A flat sealing ring according to claim 8, wherein the at least one protective layer (4) is produced from a chemically resistant material.

13. A flat sealing ring according to claim 5 wherein the at least one protective layer (4) is produced from a fluoropolymer.

14. A flat sealing ring according to claim 6 wherein the at least one protective layer (4) is produced from a fluoropolymer.

15. A flat sealing ring according to claim 5 wherein the at least one protective layer (4) is produced from polytetrafluoroethylene (PTFE).

16. A flat sealing ring according to claim 6 wherein the at least one protective layer (4) is produced from polytetrafluoroethylene (PTFE).

17. A flat sealing ring according to claim 5 wherein the stiffening ring (3, 3′, 3″) and the protective layer (4) are produced as a single piece from the same material.

18. A flat sealing ring according to claim 6 wherein the stiffening ring (3, 3′, 3″) and the protective layer (4) are produced as a single piece from the same material.

19. A flat sealing ring according to claim 7 wherein the stiffening ring (3, 3′, 3″) and the protective layer (4) are produced as a single piece from the same material.

20. A flat sealing ring according to claim 8 wherein the stiffening ring (3, 3′, 3″) and the protective layer (4) are produced as a single piece from the same material.
